(19) United States
(12) Patent Application Publication
(10) Pub. No.: US 2006/0282713 A1
(43) Pub. Date: Dec. 14, 2006

(54) Efficient interleaver/de-interleaver desigh for the turbo decoder in a 3g wcdma system

(76) Inventors: Yi Weng, Carlsbed, CA (US); Ganning Yang, Irvine, CA (US); Chiaming Lo, Irvine, CA (US)

Correspondence Address: WILLIAM J. KOLEGRAFF, 3119 TURNBERRY WAY, JAMUL, CA, 91935, US

(21) Appl. No.: 11/140,703

(22) Filed: May 31, 2005

(51) Int. Cl. G06F 11/00

(52) U.S. Cl. 714/701

(57) ABSTRACT

A device, such as an interleaver, a de-interleaver, or other devices, for interleaving or de-interleaving a signal within a wireless communication system. The device may interleave or de-interleave the signal spontaneously using a pseudo-random logic. Interleaving or de-interleaving the signal spontaneously may enable one or more features of the device to be enhanced. For example, less RAM may be required to interleave or de-interleave the signal, a die size of the device may be decreased, or other features may be enhanced. The device may receive a signal including a plurality of symbols. The plurality of symbols may be organized into one or more symbol blocks. While a number of symbols in the symbol blocks may vary from block to block, all (or substantially all) of the symbol blocks may be augmented to be of a fixed block length. Dummy bits may be used to augment the symbol blocks.

### RELATED APPLICATIONS

This application is related to a co-pending patent application titled “System and Method for Forward and Backward Recursive Computation,” Attorney Docket No. 26169-154, filed herewith on DATE, 2004, and Incorporated herein by reference.

### FIELD OF THE INVENTION

The invention is related to a device for interleaving or de-interleaving a signal within a wireless communication system.

### BACKGROUND OF THE INVENTION

Recently, various aspects of wireless communication systems have become more and more advanced. For example, aspects such as increased bandwidth, increased range, decreased interference, or other aspects have become more enhanced. Some of these enhancements have been achieved by using increasingly complex encoded signals. For example, some conventional systems use turbo codes to encode signals within a wireless communication system.

Interleaving a signal within a wireless communication system may enhance some aspects of wireless communication by alleviating various types of error, such as, random error, burst error, or other errors. Interleaving is commonly implemented using one-to one mapping. However, the increasing complexity of recently implemented codes, such as turbo codes or other codes, may add to one or more costs associated with interleaving a signal within a wireless communication system using a one-to-one mapping method. These costs may include an increased die size, an increased RAM requirement, an increased cycle count, or other costs.

Consequently, there is a need for a device, such as an interleaver, a de-interleaver, or other device, for interleaving or de-interleaving a signal within a wireless communication system that may provide one or more enhancements, such as, a decreased die size, a decreased RAM requirement, or other enhancements.

### SUMMARY

One aspect of the invention may relate to a device, such as an Interleaver, a de-interleaver, or other device, for interleaving or de-interleaving a signal within a wireless communication system. The device may interleave or de-interleave the signal spontaneously, or “on the fly”, using a pseudo-random logic. Interleaving or de-interleaving the signal spontaneously may enable one or more features of the device to be enhanced. For example, less RAM may be required to interleave or de-interleave the signal, a die size of the device may be decreased, or other features may be enhanced.

In some embodiments of the invention, the device may receive a signal including a plurality of symbols. The plurality of symbols may be organized into one or more symbol blocks. While a number of symbols in the symbol blocks may vary from block to block, all (or substantially all) of the symbol blocks may be augmented to be of a fixed block length. For example, dummy bits may be used to augment the symbol blocks.

According to various embodiments of the invention, the device may include a dummy bit section. The dummy bit section may monitor the signal as it is received by the device. Based on the monitoring of the signal, the dummy bit section may generate an appropriate number of dummy bits to augment the symbol blocks of the signal and thereby enable the symbol blocks to be of the fixed block length. The symbols and dummy bits may be received by a device hardware core. The device hardware core may hold all or part of a symbol block prior to the symbol block being output. The symbol blocks may be output according to an output order. The device may include an output order generator.

In some embodiments of the invention, the dummy bit section may include a plurality of dummy bit sub-sections. The dummy bit sub-sections may monitor and/or generate dummy bits for signal blocks in an alternating or sequential fashion. This may enable one dummy bit sub-section to monitor one symbol block as another dummy bit sub-section is generating dummy bits to augment a previous symbol block.

According to various embodiments, a dummy bit sub-section may include a counter. The counter may count, or otherwise enumerate, a signal value, such as, a number of symbols received, a number of dummy bits generated, a block length of a symbol block being received and/or augmented, or other values. The dummy bit sub-section may use the count provided by the counter to monitor and/or control various aspects of the dummy bit sub-section. For example, when dummy bits are to be generated, how many dummy bits are to be generated, or other aspects may be controlled.

The dummy bit sub-section may include a counter table. The counter table may store various information related to the counter, such as, an initial counter value, an end counter value, or other information. The counter table may enable the dummy bit sub-section to use information generated by the counter to monitor and/or control the various aspects of the dummy bit sub-section.

The dummy bit sub-section may include a dummy bit table. The dummy bit table may store and/or generate dummy bits. Dummy bits generated by the dummy bit table may be used to augment the symbol blocks.

In some embodiments, the device hardware core may receive the symbols and dummy bits. The device hardware core may include one or more recordable storage media, such as, RAM, ROM, an optical medium, a magnetic medium, a hard drive, or other media. The device may hold the symbols and dummy bits as symbol blocks of a fixed block length. Holding the symbols and dummy bits as symbol blocks of a fixed block length may include recording the symbols and dummy bits of a symbol block sequentially as they are received. For example, the symbols and dummy bits of a symbol block may be sequentially read into RAM storage. Other methods of holding symbols and dummy bits of a symbol block sequentially exist.

According to various embodiments of the invention, the output order generator may generate an output order for each symbol block. The output order may be spontaneously generated using a pseudo-random logic. The output order generator may remove the dummy bits from the signal for output. In some embodiments, the symbol blocks may be read out of one or more recordable storage media in the order generated by the output order generator. The recordable storage media may be associated with the device hardware core.

### BRIEF DESCRIPTION OF THE DRAWINGS

FIG. 1 illustrates an exemplary embodiment of an interleaver.

FIG. 2 illustrates an exemplary embodiment of a de-interleaver.

FIG. 3 illustrates an exemplary embodiment of a dummy bit sub-section.

### DETAILED DESCRIPTION OF THE DRAWINGS

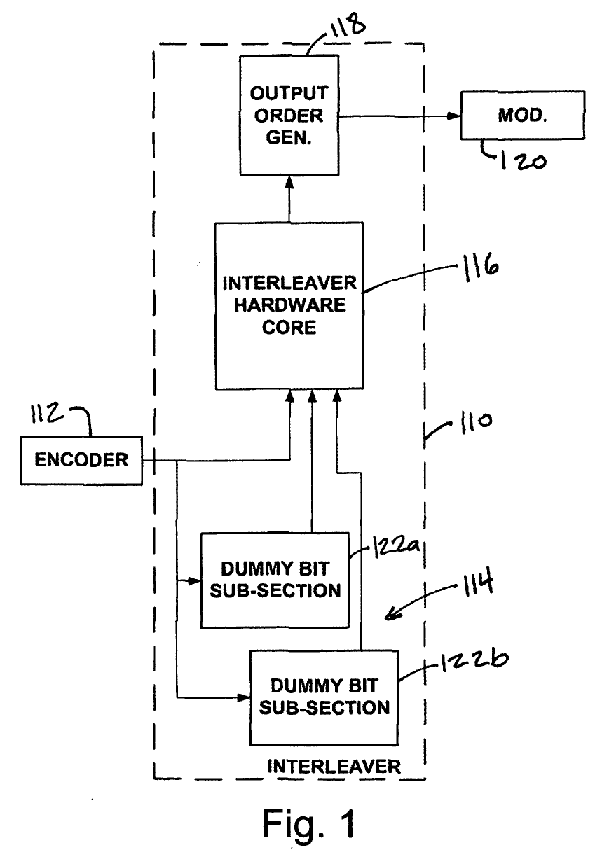

FIG. 1 illustrates an exemplary embodiment of an interleaver 110. Interleaver 110 may receive a signal from an encoder 112. Encoder 112 may be similar to an embodiment of an encoder disclosed in the related patent application titled “System and Method for Forward and Backward Recursive Computation,” U.S. patent application Ser. No. ______. The signal may include a plurality of symbols. The plurality of symbols may be organized into one or more symbol blocks. While a number of symbols in the symbol blocks may vary from block to block, all (or substantially all) of the symbol blocks may be augmented to be of a fixed block length. Dummy bits may be used to augment the symbol blocks.

According to various embodiments of the invention, interleaver 110 may include a dummy bit section 114. Dummy bit section 114 may monitor the signal as it is received by interleaver 110. Based on the monitoring of the signal, dummy bit section 114 may generate an appropriate number of dummy bits to augment the symbol blocks of the signal and thereby enable the symbol blocks to be of the fixed block length. The symbols and dummy bits may be received by an interleaver hardware core 116. Interleaver hardware core 116 may hold all or part of a symbol block prior to the symbol block being output. The symbol blocks may be output according to an output order. The output order may be generated by an output order generator 118. The symbol blocks may be output to a modulator 120.

In some embodiments of the invention, dummy bit section 114 may include a plurality of dummy bit sub-sections 122 (illustrated as 122a, and 122b). Dummy bit sub-sections 122 may monitor and/or generate dummy bits for signal blocks in an alternating or sequential fashion. This may enable one dummy bit sub-section 122a to monitor one symbol block as another dummy bit sub-section 122b is generating dummy bits to augment a previous symbol block.

In some embodiments, interleaver hardware core 116 may receive the symbols and dummy bits. Interleaver hardware core 116 may include one or more recordable storage media, such as, RAM, ROM, an optical medium, a magnetic medium, a hard drive, a floppy disk, a compact disk, or other media. Interleaver hardware core 116 may hold the symbols and dummy bits as symbol blocks of a fixed block length. Holding the symbols and dummy bits as symbol blocks of a fixed block length may include recording the symbols and dummy bits of a symbol block sequentially as they are received. For example, the symbols and dummy bits of a symbol block may be sequentially read into RAM storage. Other methods of holding symbols and dummy bits of a symbol block sequentially exist.

According to various embodiments of the invention, output order generator 118 may generate an output order for each symbol block. The output order may be spontaneously generated using a pseudo-random logic. Output order generator 118 may remove the dummy bits from the signal for output. In some embodiments, the symbol blocks may be read out of one or more recordable storage media in the order generated by output order generator 118. The recordable storage media may be associated with interleaver hardware core 116.

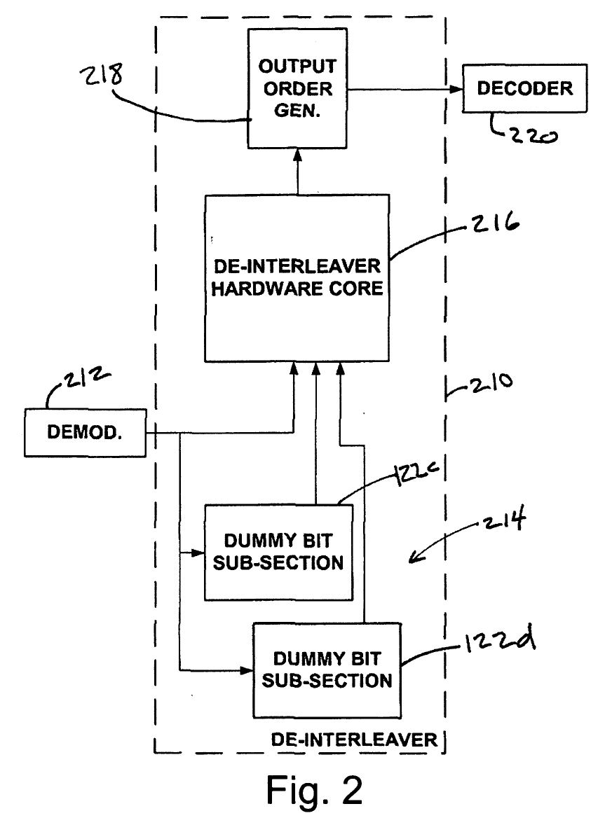

FIG. 2 illustrates an exemplary embodiment of an de-interleaver 210. De-interleaver 210 may receive a signal from a demodulator 212. The signal may include a plurality of symbols. The plurality of symbols may be organized into one or more symbol blocks. While a number of symbols in the symbol blocks may vary from block to block, all (or substantially all) of the symbol blocks may be augmented to be of a fixed block length. Dummy bits may be used to augment the symbol blocks.

According to various embodiments of the invention, de-interleaver 210 may include a dummy bit section 214. Dummy bit section 214 may monitor the signal as it is received by de-interleaver 210. Based on the monitoring of the signal, dummy bit section 214 may generate an appropriate number of dummy bits to augment the symbol blocks of the signal and thereby enable the symbol blocks to be of the fixed block length. The symbols and dummy bits may be received by a de-interleaver hardware core 216. De-interleaver hardware core 218 may hold all or part of a symbol block prior to the symbol block being output. The symbol blocks may be output according to an output order. The output order may be generated by an output order generator 218. The symbol blocks may be output to a decoder 220. Decoder 220 may be similar to an embodiment of a decoder disclosed in the related patent application titled “System and Method for Forward and Backward Recursive Computation,” Attorney Docket No. 26169-154.

In some embodiments of the invention, dummy bit section 214 may include a plurality of dummy bit sub-sections 122 (illustrated as 122c, and 122d). Dummy bit sub-sections 122 may monitor and/or generate dummy bits for signal blocks in an alternating or sequential fashion. This may enable one dummy bit sub-section 122c to monitor one symbol block as another dummy bit sub-section 122d is generating dummy bits to augment a previous symbol block.

In some embodiments, de-interleaver hardware core 216 may receive the symbols and dummy bits. De-interleaver hardware core 216 may include one or more recordable storage media, such as, RAM, ROM, an optical medium, a magnetic medium, a hard drive, or other media. De-interleaver hardware core 216 may hold the symbols and dummy bits as symbol blocks of a fixed block length. Holding the symbols and dummy bits as symbol blocks of a fixed block length may include recording the symbols and dummy bits of a symbol block sequentially as they are received. For example, the symbols and dummy bits of a symbol block may be sequentially read into RAM storage. Other methods of holding symbols and dummy bits of a symbol block sequentially exist.

According to various embodiments of the invention, output order generator 218 may generate an output order for each symbol block. The output order may be spontaneously generated using a pseudo-random logic. Output order generator 118 may remove the dummy bits from the signal for output. In some embodiments, the symbol blocks may be read out of one or more recordable storage media in the order generated by output order generator 218. The recordable storage media may be associated with interleaver hardware core 116.

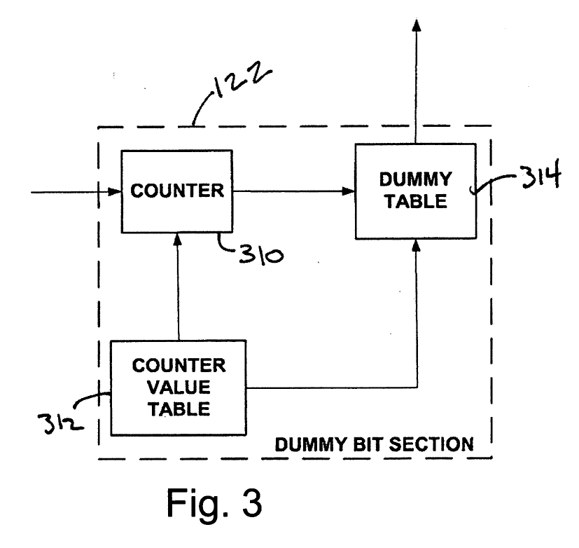

FIG. 3 illustrates an exemplary embodiment of dummy bit sub-section 122. Dummy bit sub-section 122 may include a counter 310. Counter 310 may count, or otherwise enumerate, a signal value, such as, a number of symbols received, a number of dummy bits generated, a block length of a symbol block being received and/or augmented, or other values. Dummy bit sub-section 122 may use the count provided by counter 310 to monitor and/or control various aspects of dummy bit sub-section 122. For example, when dummy bits are to be generated, how many dummy bits are to be generated, or other aspects may be controlled.

Dummy bit sub-section 122 may include a counter table 312. Counter table 312 may store various information related to counter 310, such as, an initial counter value, an end counter value, or other information. Counter table 312 may enable dummy bit sub-section 122 to use information generated by counter 310 to monitor and/or control the various aspects of dummy bit sub-section 122.

Dummy bit sub-section 122 may include a dummy bit table 314. Dummy bit table 314 may store and/or generate dummy bits. Dummy bits generated by dummy bit table 314 may be used to augment the symbol blocks.

What is claimed is:

1. An interleaver for interleaving a signal in a wireless communication system, the signal including at least one symbol block of a fixed block length, the symbol block including at least one symbol and at least one dummy bit, the interleaver comprising:
a dummy bit section that determines a required number of dummy bits such that the symbol block will be of the fixed block length, and that provides the required number of dummy bits as the signal is received by the interleaver;
an interleaver hardware core that holds the symbols and the dummy bits; and
an output order generator that spontaneously generates an output order for outputting the symbols and the dummy bits from the interleaver hardware core using a pseudo-random logic.

2. The interleaver of claim 1 wherein the dummy bit section includes a plurality of dummy bit sub-sections that provide dummy bits for alternating signal blocks.

3. The interleaver of claim 1 wherein the dummy bit section includes at least one counter.

4. The interleaver of claim 1 wherein the dummy bit section includes at least one dummy bit table that provides dummy bits to the signal.

5. The interleaver of claim 1 wherein holding the symbols and dummy bits includes sequentially recording the symbols and the dummy bits.

6. A method for interleaving a signal in a wireless communication system, the signal including at least one symbol block of a fixed block length, the symbol block including at least one symbol and at least one dummy bit, the method comprising:
counting the symbols in the symbol block;
providing an appropriate number of dummy bits such that the symbol block is of the fixed block length;
holding the symbol block;
spontaneously generating an output order for outputting the symbols and dummy bits of the symbol block using a pseudo-random logic; and
outputting the symbol block based on the output order.

7. The method of claim 6 wherein the dummy bits are provided by a dummy bit table.

8. The method of claim 6 wherein holding the symbol block includes sequentially recording the symbols and the dummy bits of the symbol block.

9. A de-interleaver for de-interleaving a signal in a wireless communication system, the signal including at least one symbol block of a fixed block length, the symbol block including at least one symbol and at least one dummy bit, the de-interleaver comprising:
a dummy bit section that determines a required number of dummy bits such that the symbol block will be of the fixed block length, and that provides the required number of dummy bits as the signal is received by the de-interleaver;
a de-interleaver hardware core that holds the symbols and the dummy bits; and
an output order generator that spontaneously generates an output order for outputting the symbols and the dummy bits from the de-interleaver hardware core using a pseudo-random logic.

10. The de-interleaver of claim 9 wherein the dummy bit section includes a plurality of dummy bit sub-sections that provide dummy bits for alternating signal blocks.

11. The de-interleaver of claim 9 wherein the dummy bit section includes at least one counter.

12. The de-interleaver of claim 9 wherein the dummy bit section includes at least one dummy bit table that provides dummy bits to the signal.

13. The de-interleaver of claim 9 wherein holding the symbols and dummy bits includes sequentially recording the symbols and the dummy bits.

14. A method for de-interleaving a signal in a wireless communication system, the signal including at least one symbol block of a fixed block length, the symbol block including at least one symbol and at least one dummy bit, the method comprising:
counting the symbols in the symbol block;
providing an appropriate number of dummy bits such that the symbol block is of the fixed block length;
holding the symbol block;
spontaneously generating an output order for outputting the symbols and dummy bits of the symbol block using a pseudo-random logic; and
outputting the symbol block based on the output order.

15. The method of claim 14 wherein the dummy bits are provided by a dummy bit table.

16. The method of claim 14 wherein holding the symbol block includes sequentially recording the symbols and the dummy bits of the symbol block.
